(19) United States
(12) Patent Application Publication
(10) Pub. No.: US 2003/0145672 A1
(43) Pub. Date: Aug. 7, 2003

(54) Ball screw drive

(75) Inventor: Kurt Husistein, Burg AG (CH)

Correspondence Address: GREENBLUM & BERNSTEIN, P.L.C., 1950 ROLAND CLARKE PLACE, RESTON, VA, 20191, US

(73) Assignee: Eichenberger Gewinde AG, Burg AG (CH)

(21) Appl. No.: 10/345,254

(22) Filed: Jan. 16, 2003

(30) Foreign Application Priority Data
Feb. 7, 2002 (CH) 2002 0208/02

(51) Int. Cl. F16H 25/22

(52) U.S. Cl. 74/424.85; 74/424.82

(57) ABSTRACT

Ball screw drive including threaded spindle and threaded nut body. Nut body is axially displaceable on spindle, and threaded grooves of the spindle and the nut body are arranged to form load-bearing ball channel. Return channel is provided, as is plurality of balls for movement through load-bearing ball channel and return channel. Return channel is structured so that balls moving through return channel are not under stress. At least one of spindle and nut body have at least one additional groove parallel to load-bearing channel, and return channel includes the additional groove. End caps arranged at opposite ends of nut body are structured and arranged to transfer balls from load-bearing ball channel to return channel and from return channel to load-bearing ball channel. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of Swiss Patent Application No. 2002 0208/02 filed on Feb. 7, 2002, the disclosure of which is expressly incorporated by reference herein in its entirety.

### BACKGROUND OF THE INVENTION

1. Field of the Invention

The present invention relates to a ball screw drive with a threaded spindle and with a nut body that is axially displaceable on the threaded spindle by a rotary movement of the threaded spindle. The nut body features at least one thread groove, in which balls are arranged as load-bearing bodies between the thread grooves of the threaded spindle and of the nut body, which are arranged to face one another, and both ends of each load-bearing thread groove are provided with ball guide bodies, which are connected via a return channel area for the balls.

2. Discussion of Background Information

A ball screw drive of the type mentioned at the outset is known from German Patent Application No. DE-A1-198 57 581. Abutting balls are arranged between the thread grooves of the threaded spindle and the nut body as load-bearing connection between the spindle and the nut body. The threaded spindle features a central bore that serves as return channel for the balls. The balls are diverted at both ends of the ball channel area out of the load-bearing thread grooves into the return channel of the threaded spindle and vice versa by ball guide bodies installed in the threaded spindle. A great disadvantage of this ball screw drive is that it can only be used in the ball circulation area. As soon as the nut body leaves the ball circulation area, the balls fall out of the thread grooves, whereby the ball screw drive loses its operability. For this reason the nut body has to be embodied in a relatively long manner, corresponding to the largest stroke of the ball screw drive. The ball screw drive therefore not only has relatively large dimensions but also economic disadvantages.

### SUMMARY OF THE INVENTION

The present invention provides a ball screw drive of the type mentioned at the outset, which features the maximum stroke covering the full free length of the threaded spindle, is simply structured and economically advantageous.

In this regard, the present invention includes at least one of a spindle and a nut body having at least two parallel thread grooves. At least one of the thread grooves is a thread groove bearing balls under stress or load and at least another of the thread grooves is a return groove used for the return of non-load-bearing balls. Moreover, end caps are provided between the load-bearing thread grooves and the return grooves, and are attached to the nut body to divert the balls from the load-bearing thread grooves into the neighboring return groove and vice versa. The production of a spindle and/or of a nut body with a multiple-thread screw is economically advantageous. It can also be achieved in a simple manner that at least one thread groove is embodied as non-load-bearing. The diversion of the circulating balls from a load-bearing thread groove into a neighboring return groove can be made with the aid of simple guide bodies. Further, as this ball rotary drive can be operated over the entire free length of the threaded spindle, it is structured simply and is economically advantageous.

The return groove provided for the return of the balls is advantageously arranged in the threaded spindle and therein includes a deeper, non-load-bearing thread groove, whereby this thread groove is deeper than the diameter of the balls. A threaded spindle with a multiple-thread screw provided with unequally deep thread grooves can be simply produced by economically advantageous means.

The return groove provided for the return of the balls can also be arranged in the nut body and therein includes a deeper, non-load-bearing thread groove, whereby this thread groove is deeper than the diameter of the balls. The production of a nut body with unequally deep thread grooves is possible in a simple manner in an economically advantageous manner.

The return groove provided for the return of the balls can also be in two parts and includes two deeper non-load-bearing thread grooves facing one another arranged both in the threaded spindle and in the nut body, whereby the sum of the depths of these thread grooves is greater than the diameter of the balls. In this embodiment the load-bearing cross section of the components of the ball screw drive is weakened relatively little, because the return channel is formed by two thread grooves guided in both the threaded spindle and in the nut body. This solution thus provides an optimum mechanical strength of the ball screw drive.

The present invention is directed to a ball screw drive that includes a spindle including at least one threaded groove and a nut body including at least one threaded groove. The nut body is structured and arranged to be axially displaceable on the spindle, and the at least one threaded groove of the spindle and the at least one groove of the nut body are arranged to form a load-bearing ball channel. A return channel is provided, as well as a plurality of balls arranged for movement through the load-bearing ball channel and the return channel. The return channel is structured so that the balls are not under stress as they move through the return channel. At least one of the spindle and the nut body have at least one additional groove arranged parallel to the load-bearing channel, such that the return channel includes the at least one additional groove. End caps arranged at opposite ends of the nut body are structured and arranged to transfer the balls from the load-bearing ball channel to the return channel and from the return channel to the load-bearing ball channel.

According to a feature of the invention, the nut body can be axially displaceable on the spindle via rotary movement of at least one of the spindle and the nut body.

In accordance with another feature of the present invention, the nut body is rotatably coupled to the spindle through the balls.

Moreover, the return channel can be located only within the spindle, and the return channel may be structured to be deeper than the load-bearing channel, and can be structured to be deeper than a diameter of the balls.

Further, the return channel may be located only within the nut body, and the return channel can be structured to be deeper than the load-bearing channel, and may be structured to be deeper than a diameter of the balls.

Still further, both the spindle and the nut body can include an additional groove, and the additional grooves can be arranged to form the return channel. The return groove may be structured to be deeper than the load-bearing channel. In particular, the additional groove on the nut body can be deeper than the at least one groove on the nut body and/or the additional groove on the spindle can be deeper than the at least one groove on the spindle. Further, a sum of depths of the additional grooves may be greater than a diameter of the balls.

The present invention is directed to a ball screw drive that includes a spindle and a nut body. The nut body is arranged on the spindle to be axially displaceable along the spindle, and the nut body and the spindle are structured and arranged to form a channel. At least one of the spindle and the nut body include at least one groove arranged parallel to the channel, and end caps arranged at opposite ends of the nut body are structured and arranged to couple the channel to the at least one groove.

According to a feature of the present invention, the ball screw drive may further include a plurality of balls, such that the end caps are structured and arranged to enable movement of the balls from the channel to the at least one groove and from the at least one groove to the channel.

In accordance with another feature of the instant invention, the channel can be structured and arranged so that the balls in the channel are under stress. Further, the at least one groove can be a deeper than the channel, such that the balls in the at least one groove are not under stress.

Further, the at least one groove may be located only within the spindle, and the at least one groove can be structured to be deeper than a diameter of the balls.

Still further, the at least one groove can be located only within the nut body, and the at least one groove can be structured to be deeper than a diameter of the balls.

Moreover, both the spindle and the nut body can include an additional groove, and the additional grooves can be arranged to form an additional channel. The additional channel may be structured to be deeper than the channel, and a sum of depths of the additional grooves can be greater than a diameter of the balls.

The present invention is directed to a process of guiding balls within a ball screw drive that includes a spindle and a nut body arranged to form a channel, and a plurality of balls movably arranged within the channel. The process includes at least one of transferring the balls within the channel to an additional channel arranged parallel to the channel and transferring balls within the additional channel to the channel. The transferring occurs through end caps arranged on opposite ends of the nut body, and the additional channel is structured to allow movement of the balls.

In accordance with a feature of the invention, the additional channel is deeper than a diameter of the balls and is located only in the nut body, and the process can further include moving the balls through the nut body while not under a load. The balls moving in the channel are under load.

According to another feature of the instant invention, the additional channel is deeper than a diameter of the balls and is located only in the spindle, and the process can further include moving the balls through the spindle while not under a load. The balls moving in the channel are under load.

In accordance with still yet another feature of the present invention, the additional channel is deeper than a diameter of the balls and is located in both the spindle and the nut body, and the process may further include moving the balls through the additional channel while not under a load. The balls moving in the channel are under load.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a sectional view of a ball screw drive having a threaded spindle with a return groove and a nut body without end caps;

FIG. 2 illustrates a sectional view of the ball screw drive with a diagrammatic depiction of the circulating balls;

FIG. 3 illustrates a sectional view of a ball screw drive having a nut body with a return groove without end caps in section; and

FIG. 4 illustrates a sectional view of the ball screw drive with a return channel formed by facing thread grooves in the threaded spindle and in the nut body.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

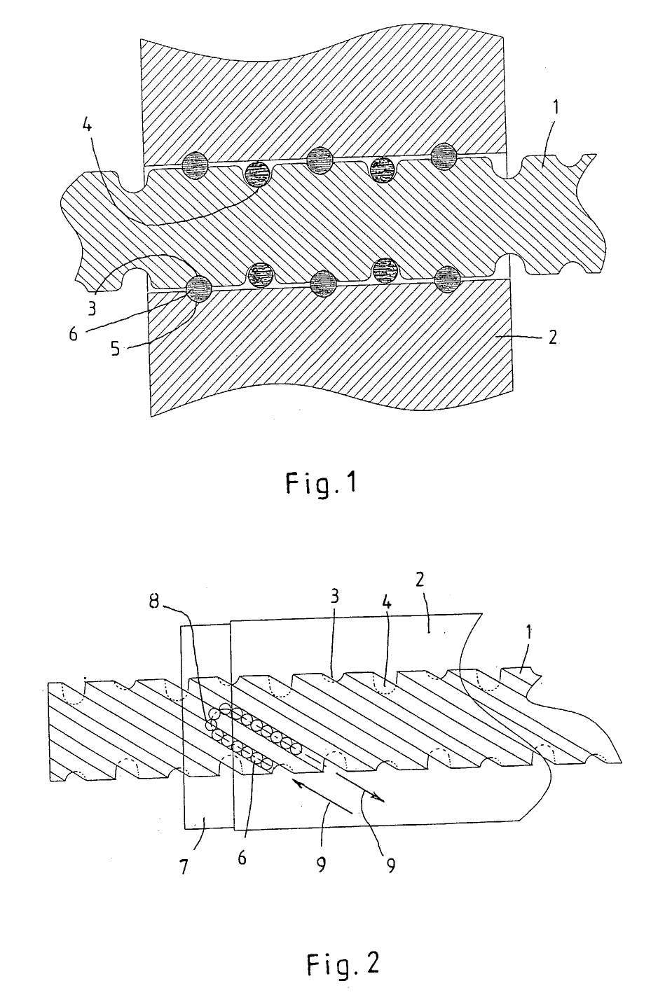

FIG. 1 shows a section of a ball screw drive with a threaded spindle 1 and with a nut body 2. By a rotary movement of threaded spindle 1, nut body 2 can be displaced on it. In the exemplary embodiment, threaded spindle 1 includes two parallel thread grooves 3 and 4. Only one thread groove 5 is provided in nut body 2. Balls 6, arranged to transfer the load of the ball screw drive, lie between thread groove 3 of threaded spindle 1 and thread groove 5 of nut body 2. Thread groove 4 of threaded spindle 1 is formed deeper within threaded spindle 1 such that balls 6 guided therein do not touch nut body 2 at all, e.g., thread grooves 4 are deeper than the diameter of balls 6. Moreover, thread groove 4 is formed as a return groove to return balls 6, arriving at the end of nut body 2, back to the beginning of nut body 2.

The diversion of balls 6 at the end of nut body 2 from load-bearing thread groove 5 into neighboring return groove 4 and vice versa occurs in end caps 7 (only one of which is diagrammatically represented in FIG. 2). A channel 8 is provided in end cap 7 for the diversion of balls 6. A ball guide pin (not shown) is located at the channel entrance in thread groove 5. Balls 6 run through channel 8 in the direction indicated by arrow 9, i.e., from load-bearing thread groove 3 and 5 into return groove 4. After reversal of the direction of the rotary movement between threaded spindle 1 and nut body 2, balls 6 run in channel 8 in the opposite direction. The great advantage of this arrangement is that return channel 4 does not need to be manufactured by any expensive precision bores in threaded spindle 1 or in nut body 2, but can be made by a simple recess of at least one thread groove 4. Moreover, with this arrangement nothing projects beyond the relatively short nut body 2 in the radial direction, so small dimensions are ensured.

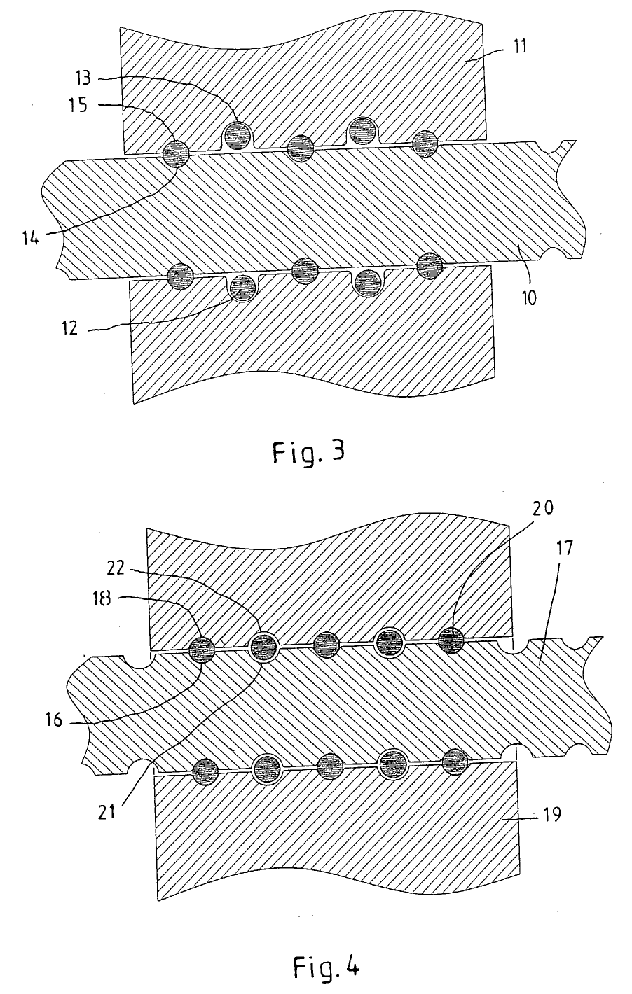

FIG. 3 shows a sectional view of an alternative arrangement of the ball screw device in accordance with the instant invention. In this exemplary embodiment, the ball screw device includes a threaded spindle 10 and a nut body 11, however, the return channel for balls 12 is provided by a deeper thread groove 13 located within nut body 11. As in the previous embodiment, thread groove 13 is deeper than the diameter of balls 12. Moreover, balls 12 bearing the axial stress of the ball screw drive are guided in facing thread grooves 14 and 15 of threaded spindle 10 and nut body 11, respectively. End caps 7 are attached at both ends of nut body 11, as depicted in FIG. 2, in order to divert balls 12 from load-bearing thread grooves 14 and 15 into deeper thread groove 13 (i.e., return channel) and back to the other end of nut body 11. With this arrangement, too, the production of the return channel is cost-effective and the relatively small dimensions of the ball screw drive are also ensured.

FIG. 4 shows another exemplary embodiment of the ball screw drive in accordance with the instant invention. In this exemplary embodiment, the return channel is embodied or formed in two parts. That is, the return channel is formed by facing thread grooves 21 and 22 in threaded spindle 17 and nut body 19, respectively. Moreover, as in the previous embodiments, the return channel has a depth greater than the diameters of balls 20, i.e., the sum of the depths of thread grooves 21 and 22 is greater than the diameter of the balls 20. Further, load-bearing balls 20 are guided between facing thread grooves 16 and 18 in threaded spindle 17 and nut body 19, respectively. According to this arrangement, because the return channel does not require such a deep cut in the load-bearing cross section, the cross section of the load-bearing portions of threaded spindle 17 and nut body 19 in the axial direction is weakened less than in the embodiments depicted in FIGS. 1 or 3. In this regard, it is noted that thread grooves 21 and 22 forming the return channel are only approximately half as deep as thread grooves 4 and 13 in FIGS. 1 and 3, respectively. The cross section that is load-bearing in the longitudinal direction remains correspondingly larger and therefore has a greater loading capacity.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A ball screw drive comprising:
a spindle comprising at least one threaded groove;
a nut body comprising at least one threaded groove, said nut body being structured and arranged to be axially displaceable on said spindle;
said at least one threaded groove of said spindle and said at least one groove of said nut body being arranged to form a load-bearing ball channel;
a return channel;
a plurality of balls arranged for movement through said load-bearing ball channel and said return channel, wherein said return channel is structured so that said balls are not under stress as they move through said return channel;
at least one of said spindle and said nut body comprising at least one additional groove arranged parallel to said load-bearing channel, such that said return channel comprises said at least one additional groove; and
end caps arranged at opposite ends of said nut body structured and arranged to transfer the balls from said load-bearing ball channel to said return channel and from said return channel to said load-bearing ball channel.

2. The ball screw drive in accordance with claim 1, wherein said nut body is axially displaceable on said spindle via rotary movement of at least one of said spindle and said nut body.

3. The ball screw drive in accordance with claim 1, wherein said nut body is rotatably coupled to said spindle through said balls.

4. The ball screw drive in accordance with claim 1, wherein said return channel is located only within said spindle.

5. The ball screw drive in accordance with claim 4, wherein said return channel is structured to be deeper than said load-bearing channel.

6. The ball screw drive in accordance with claim 5, wherein said return channel is structured to be deeper than a diameter of said balls.

7. The ball screw drive in accordance with claim 1, wherein said return channel is located only within said nut body.

8. The ball screw drive in accordance with claim 7, wherein said return channel is structured to be deeper than said load-bearing channel.

9. The ball screw drive in accordance with claim 8, wherein said return channel is structured to be deeper than a diameter of said balls.

10. The ball screw drive in accordance with claim 1, wherein both of said spindle and said nut body comprise an additional groove, and said additional grooves are arranged to form said return channel.

11. The ball screw drive in accordance with claim 10, wherein said return groove is structured to be deeper than said load-bearing channel.

12. The ball screw drive in accordance with claim 10, wherein said additional groove on said nut body is deeper than said at least one groove on said nut body.

13. The ball screw drive in accordance with claim 12, wherein said additional groove on said spindle is deeper than said at least one groove on said spindle.

14. The ball screw drive in accordance with claim 10, wherein said additional groove on said spindle is deeper than said at least one groove on said spindle.

15. The ball screw drive in accordance with claim 10, wherein a sum of depths of said additional grooves is greater than a diameter of said balls.

16. A ball screw drive comprising:
a spindle;
a nut body;
said nut body being arranged on said spindle to be axially displaceable along said spindle, and said nut body and said spindle being structured and arranged to form a channel;
at least one of said spindle and said nut body comprising at least one groove arranged parallel to said channel; and
end caps arranged at opposite ends of said nut body structured and arranged to couple said channel to said at least one groove.

17. The ball screw drive in accordance with claim 16, further comprising a plurality of balls, wherein said end caps are structured and arranged to enable movement of said balls from said channel to said at least one groove and from said at least one groove to said channel.

18. The ball screw drive in accordance with claim 16, wherein said channel is structured and arranged so that said balls in said channel are under stress.

19. The ball screw drive in accordance with claim 18, wherein said at least one groove is a deeper than said channel, such that said balls in said at least one groove are not under stress.

20. The ball screw drive in accordance with claim 16, wherein said at least one groove is located only within said spindle, and said at least one groove is structured to be deeper than a diameter of said balls.

21. The ball screw drive in accordance with claim 16, wherein said at least one groove is located only within said nut body, and said at least one groove is structured to be deeper than a diameter of said balls.

22. The ball screw drive in accordance with claim 16, wherein both of said spindle and said nut body comprise an additional groove, and said additional grooves are arranged to form an additional channel.

23. The ball screw drive in accordance with claim 22, wherein said additional channel is structured to be deeper than said channel.

24. The ball screw drive in accordance with claim 22, wherein a sum of depths of said additional grooves is greater than a diameter of said balls.

25. A process of guiding balls within a ball screw drive that includes a spindle and a nut body arranged to form a channel, and a plurality of balls movably arranged within the channel, said process comprising:
at least one of transferring the balls within the channel to an additional channel arranged parallel to the channel and transferring balls within the additional channel to the channel,
wherein the transferring occurs through end caps arranged on opposite ends of the nut body, and
wherein the additional channel is structured to allow movement of the balls.

26. The process in accordance with claim 25, wherein the additional channel is deeper than a diameter of the balls and is located only in the nut body, and said process further comprises moving the balls through the nut body while not under a load.

27. The process in accordance with claim 26, wherein the balls moving in the channel are under a load.

28. The process in accordance with claim 25, wherein the additional channel is deeper than a diameter of the balls and is located only in the spindle, and the process further comprises moving the balls through the spindle while not under a load.

29. The process in accordance with claim 28, wherein the balls moving in the channel are under a load.

30. The process in accordance with claim 25, wherein the additional channel is deeper than a diameter of the balls and is located in both the spindle and the nut body, and the process further comprises moving the balls through the additional channel while not under a load.

31. The process in accordance with claim 30, wherein the balls moving in the channel are under a load.
